(19) United States
(12) Patent Application Publication
(10) Pub. No.: US 2019/0388914 A1
(43) Pub. Date: Dec. 26, 2019

(54) SHOWER HEAD FLOW CONTROL STRUCTURE

(71) Applicant: Purity (Xiamen) Sanitary Ware Co., Ltd., Xiamen (CN)

(72) Inventors: Xiwen Yang, Xiamen (CN); Dongming Hu, Xiamen (CN); Ruiyin Ye, Xiamen (CN); Xingchuan Ling, Xiamen (CN); Guozhong Wu, Xiamen (CN); Weisheng Wu, Xiamen, (CN); Jinlong Wu, Xiamen (CN)

(21) Appl. No.: 16/016,677

(22) Filed: Jun. 25, 2018

(51) Int. Cl. B05B 1/32; B05B 1/18

(52) U.S. Cl. CPC B05B 1/32; E03C 2001/026; B05B 1/18

(57) ABSTRACT

A shower head flow control structure includes a water inlet assembly, a sealing seat, a primary flow restrictor, and a plurality of secondary flow restrictors. The water inlet assembly has a water inlet passage communicating with a water supply tube. The sealing seat haw a plurality of discharge holes. The inlet water passage communicates with one of the discharge holes. The primary flow restrictor is disposed in the water inlet passage. The secondary flow restrictors are disposed in the discharge holes, respectively. The primary flow restrictor has a flow rate greater than that of the secondary flow restrictors. The flow rates of the secondary flow restrictors are different from each other. The flow rate of the shower head can be controlled accurately and quickly.

### BACKGROUND OF THE INVENTION

### 1. Field of the Invention

The present invention relates to a bathroom accessory, and more particularly to a shower head flow control structure.

### 2. Description of the Prior Art

The water flow control functions of shower heads, shower nozzles, combined showers, etc. in the sanitary ware industry are all controlled by the flow of the faucet to control the shower flow of different spray patterns. This way is time-consuming and cannot control the required water flow accurately and quickly, especially for some shower heads with different spray patterns. For a shower head with different flow rates of spray patterns, a specific flow rate must be designed for the spray patterns to achieve the most comfortable spray pattern.

Accordingly, the inventor of the present invention has devoted himself based on his many years of practical experiences to solve these problems.

### SUMMARY OF THE INVENTION

The primary object of the present invention is to provide a shower head flow control structure to solve the problem of the flow control accuracy and low efficiency of the conventional shower head.

In order to achieve the aforesaid object, the shower head flow control structure of the present invention comprises a water inlet assembly, a sealing seat, a primary flow restrictor, and a plurality of secondary flow restrictors. The water inlet assembly has a water inlet passage communicating with a water supply tube. The sealing seat is sealedly connected to a lower end of the water inlet assembly. The sealing seat haw a plurality of discharge holes. The inlet water passage communicates with one of the discharge holes. The primary flow restrictor is disposed in the water inlet passage. The secondary flow restrictors are disposed in the discharge holes, respectively. The primary flow restrictor has a flow rate greater than that of the secondary flow restrictors. The flow rates of the secondary flow restrictors are different from each other.

Preferably, the water inlet assembly includes a ball joint and a ball joint holder. A lower end of the ball joint is fixed to the ball joint holder. The ball joint holder is provided with the water inlet passage.

Preferably, the flow rate of the primary flow restrictor is 2.5 GPM.

Preferably, the number of the discharge holes is two, and the number of the secondary flow restrictors is two. The flow rate of one of the secondary flow restrictors is 2.0 GPM, and the flow rate of the other secondary flow restrictor is 1.75 GPM.

Alternatively, the number of the discharge holes is three, and the number of the secondary flow restrictors is three. The flow rate of one of the secondary flow restrictor is 2.0 GPM, the flow rate of another secondary flow restrictor is 1.75 GPM, and the flow rate of the other secondary flow restrictor is 1.5 GPM.

Preferably, the shower head flow control structure further comprises a rotation support seat. An upper end of the sealing seat and the lower end of the water inlet assembly are fitted into the rotation support seat. The sealing seat is rotatably connected to the lower end of the water inlet assembly through the rotation support seat.

Preferably, the shower head flow control structure further comprises a faceplate. The faceplate is connected to a lower end of the sealing seat in a manner that can drive the sealing seat to rotate relative to the water inlet assembly.

Preferably, a side of the faceplate is provided with a rotation handle.

Preferably, the secondary flow restrictors are respectively mounted in the discharge holes of the sealing seat in a detachable manner, or the secondary flow restrictors are integrally formed in the discharge holes, respectively.

Preferably, each of the primary flow restrictor and the secondary flow restrictors is provided with an O-shaped ring or a flow control element for controlling water flow.

Preferably, a lower end of the water inlet passage is provided with a gasket to communicate with one of the discharge holes.

In the shower head flow control structure of the present invention, the water inlet assembly has the primary flow restrictor with the largest flow rate to achieve a unified control of the influent flow. At the effluent end, the discharge holes of the sealing seat is provided with the secondary flow restrictors with different flow rates to achieve the corresponding change in the flow rate of the shower water, so that the flow rate of the water flow can be adapted to different spray patterns, and the flow rate can be controlled accurately and quickly.

### BRIEF DESCRIPTION OF THE DRAWINGS

FIG. 1 is a partial exploded view in accordance with a first embodiment of the present invention;

FIG. 2 is a full exploded view in accordance with the first embodiment of the present invention;

FIG. 3 is a sectional view in accordance with the first embodiment of the present invention;

FIG. 4 is a partial exploded view in accordance with a second embodiment of the present invention;

FIG. 5 is a full exploded view in accordance with the second embodiment of the present invention;

FIG. 6 is a sectional view in accordance with the second embodiment of the present invention;

FIG. 7 is a schematic view showing the position of the faceplate and the gasket in accordance with the second embodiment of the present invention;

FIG. 8 is a schematic view showing the faceplate, the gasket and the flow control element in accordance with the second embodiment of the present invention;

FIG. 9 is a perspective view of the flow control element of the present invention; and

FIG. 10 is a sectional view of the flow control element of the present invention.

### DETAILED DESCRIPTION OF THE PREFERRED EMBODIMENTS

Embodiments of the present invention will now be described, by way of example only, with reference to the accompanying drawings.

### First Embodiment

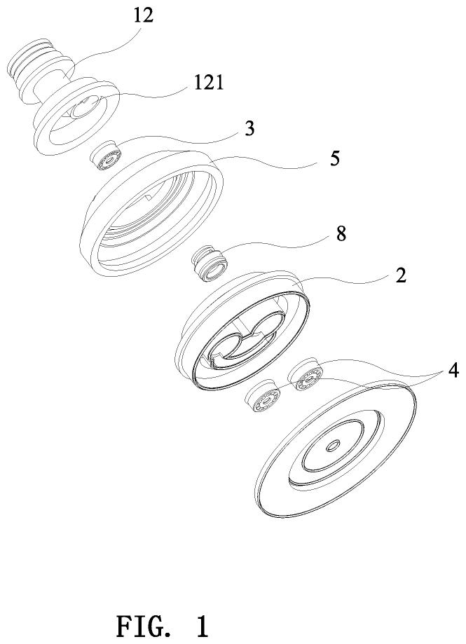

As shown in FIG. 1 to FIG. 3, the present invention discloses a shower head flow control structure, comprising a water inlet assembly 1, a sealing seat 2, a primary flow restrictor 3, and a plurality of secondary flow restrictors 4.

The water inlet assembly 1 has a water inlet passage 121 communicating with a water supply tube. The water inlet assembly may be a shower head connector, or a water inlet structure composed of a ball joint 11 and a ball joint holder 12. A lower end of the ball joint 11 is fixed to the ball joint holder 12. The ball joint holder 12 is provided with the water inlet passage 121.

The sealing seat 2 is sealedly connected to a lower end of the ball joint holder 12 of the water inlet assembly 1. The sealing seat 2 has a plurality of discharge holes 21. The inlet water passage 121 communicates with one of the discharge holes 21.

The primary flow restrictor 3 is disposed in the water inlet passage.

The secondary flow restrictors 4 are disposed in the discharge holes 21, respectively. The flow rate of the primary flow restrictor 3 is greater than the flow rates of the secondary flow restrictors 4. The flow rates of the secondary flow restrictors 4 are different from each other.

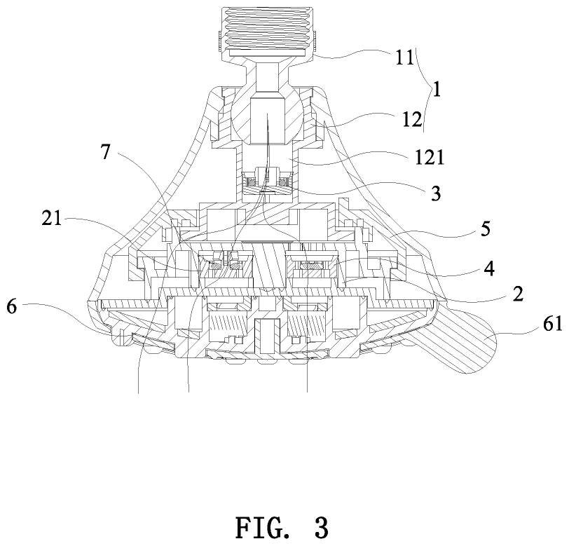

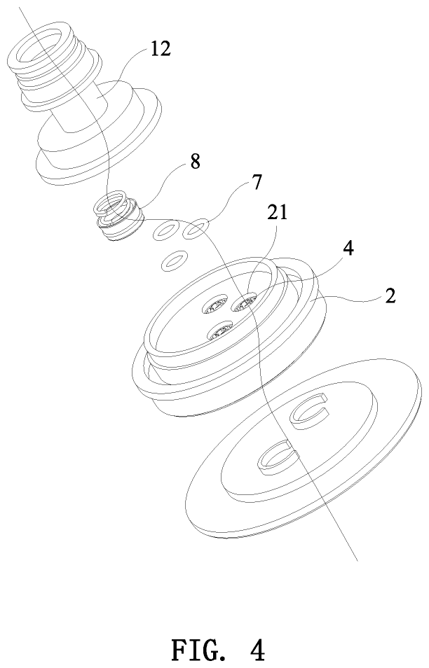

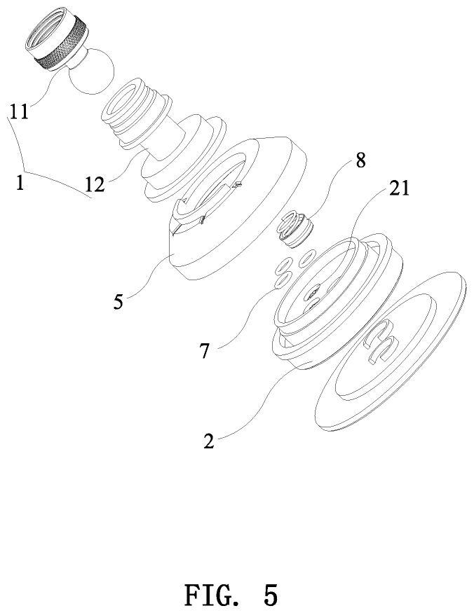

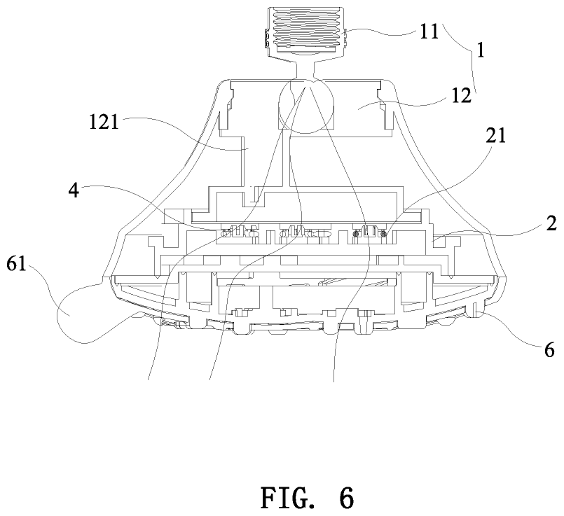

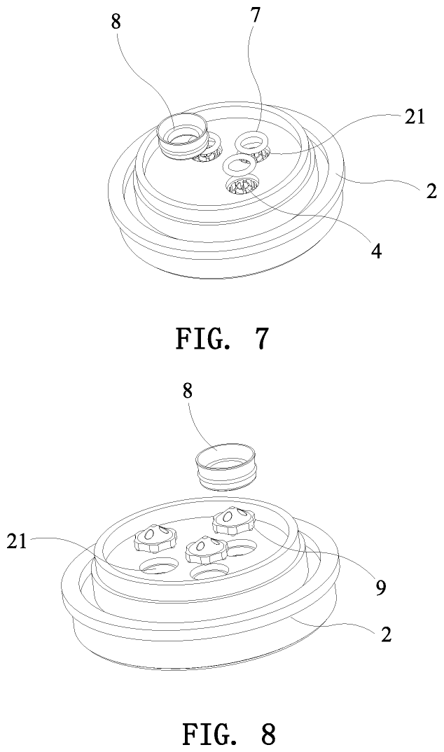

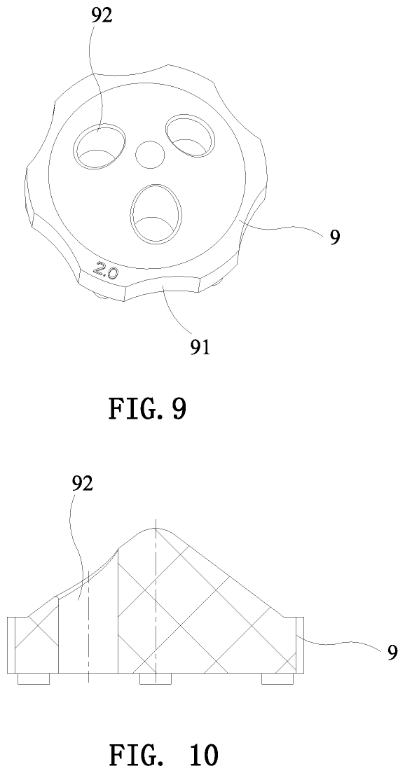

In this embodiment, the flow rate of the primary flow restrictor 3 is 2.5 GPM. The number of the discharge holes 21 is two, and the number of the secondary flow restrictors 4 is also two. The flow rate of one of the secondary flow restrictors 4 is 2.0 GPM, and the flow rate of the other secondary flow restrictor 4 is 1.75 GPM. As shown in FIG. 3, the primary flow restrictor 3 is provided with an O-shaped ring 7 for controlling the water flow. Using the O-shaped ring 7 to control the water flow is a common flow control means. Each of the secondary flow restrictors 4 is provided with an O-shaped ring 7 or a flow control element 9 for controlling the flow of water. Using the flow control element 9 to control the water flow has a better water flow stability. Referring to FIG. 9 and FIG. 10, the circumferential wall of the flow control element 9 is formed with six notches 91 spaced equally. The flow control element 9 is provided with a plurality of vertical through holes 92. Between the flow control element 9 and the bottom surface of the secondary flow restrictor 4 is defined as a water effluent area. The water flows through the notches 91 of the circumferential wall of the flow control element 9 and the through holes 92. The water flows from the water effluent area and the through holes 92 to the discharge holes 21. Since the flow control element 9 is a rubber element, the water inlet position of the flow control element 9 is deformed under water pressure. When the water pressure is low, the water inlet position of the flow control element 9 is not deformed, and the water may flow through the notches 91 to the discharge holes. When the water pressure is high, the water inlet position of the flow control element 9 is compressed to become smaller, the water effluent area is closed, and the water passes through the through holes 92 only so as to provide uniform water flow when the water pressure is high or low.

The flow rate of the primary flow restrictor 3 and the flow rate of the secondary flow restrictor 4 are not limited to the embodiments of the present invention. According to different spray patterns and water flow requirements, the flow restrictors of different flow rates can be used.

It should be clear to the person skilled in the art that the “flow control element” described in the present invention functions as an O-shaped ring 7 for controlling the water flow, that is, the “flow control element ” is a common name in the sanitary ware industry.

As shown in FIG. 1-3, in order to facilitate the installation of the sealing seat 2 and the switching of the spray patterns, the shower head flow control structure of this embodiment further includes a rotation support seat 5. The upper end of the sealing seat 2 and the lower end of the water inlet assembly 1 are fitted into the rotation support seat 5. Through the rotation support seat 5, the sealing seat 2 is rotatably connected to the lower end of the ball joint holder 12 of the water inlet assembly 1. In order to ensure the stability of the water flow, the lower end of the water inlet passage 121 is provided with a gasket 8. The gasket 8 communicates with one of the discharge holes 21. The gasket 8 and a sealing gasket are common sealing elements in the field of sanitary ware equipment. The role of the gasket 8 in the shower head of the present invention is to ensure that the water flows from the water inlet passage 121 to the discharge holes 21 smoothly.

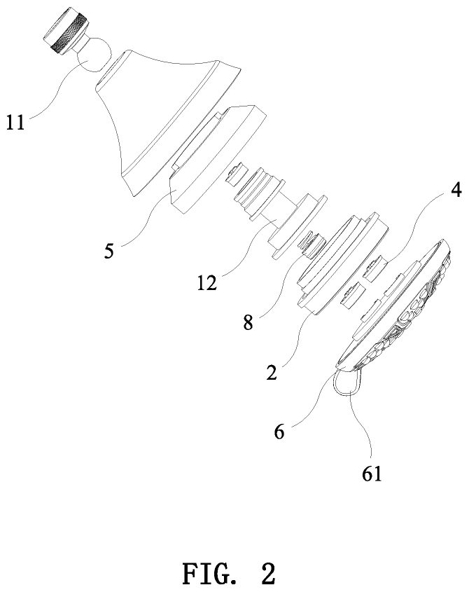

Referring to FIG. 2 and FIG. 3, in this embodiment, the shower head flow control structure further includes a faceplate 6. The faceplate 6 is connected to the lower end of the sealing seat 2 in a manner that can drive the sealing seat 2 to rotate relative to the water inlet assembly 1. In order to further simplify the switching operation of the spray patterns, the side of the faceplate 6 is provided with a rotation handle 61.

Further, the secondary flow restrictor 4 may be rotatably mounted in discharge hole of the sealing seat in a detachable manner. The secondary flow restrictor 4 may be integrally formed in the discharge hole 21.

### Second Embodiment

As shown in the figures, the second embodiment is substantially similar to the first embodiment with the exceptions described hereinafter. The number of the discharge holes 21 is three, and the number of the secondary flow restrictors 4 is also three. The flow rate of one of the secondary flow restrictors 4 is 2.0 GPM, the flow rate of another secondary flow restrictors 4 is 1.75 GPM, and the flow rate of the other secondary flow restrictor 4 is 1.5 GPM.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A shower head flow control structure, comprising:
a water inlet assembly, having a water inlet passage communicating with a water supply tube;
a sealing seat, sealedly connected to a lower end of the water inlet assembly, the sealing seat having a plurality of discharge holes, the inlet water passage communicating with one of the discharge holes;
a primary flow restrictor, disposed in the water inlet passage; and
a plurality of secondary flow restrictors, disposed in the discharge holes respectively, the primary flow restrictor having a flow rate greater than that of the secondary flow restrictors, the flow rates of the secondary flow restrictors being different from each other.

2. The shower head flow control structure as claimed in claim 1, wherein the water inlet assembly includes a ball joint and a ball joint holder, a lower end of the ball joint is fixed to the ball joint holder, and the ball joint holder is provided with the water inlet passage.

3. The shower head flow control structure as claimed in claim 1, wherein the flow rate of the primary flow restrictor is 2.5 GPM.

4. The shower head flow control structure as claimed in claim 2, wherein the number of the discharge holes is two, the number of the secondary flow restrictors is two, the flow rate of one of the secondary flow restrictors is 2.0 GPM, and the flow rate of the other secondary flow restrictor is 1.75 GPM.

5. The shower head flow control structure as claimed in claim 2, wherein the number of the discharge holes is three, the number of the secondary flow restrictors is three, the flow rate of one of the secondary flow restrictor is 2.0 GPM, the flow rate of another secondary flow restrictor is 1.75 GPM, and the flow rate of the other secondary flow restrictor is 1.5 GPM.

6. The shower head flow control structure as claimed in claim 1, further comprising a rotation support seat, an upper end of the sealing seat and the lower end of the water inlet assembly being fitted into the rotation support seat, the sealing seat being rotatably connected to the lower end of the water inlet assembly through the rotation support seat.

7. The shower head flow control structure as claimed in claim 6, further comprising a faceplate, the faceplate being connected to a lower end of the sealing seat in a manner that can drive the sealing seat to rotate relative to the water inlet assembly; a side of the faceplate being provided with a rotation handle.

8. The shower head flow control structure as claimed in claim 1, wherein the secondary flow restrictors are respectively mounted in the discharge holes of the sealing seat in a detachable manner, or the secondary flow restrictors are integrally formed in the discharge holes, respectively.

9. The shower head flow control structure as claimed in claim 1, wherein each of the primary flow restrictor and the secondary flow restrictors is provided with an O-shaped ring or a flow control element for controlling water flow.

10. The shower head flow control structure as claimed in claim 1, wherein a lower end of the water inlet passage is provided with a gasket to communicate with one of the discharge holes.
